(19) United States
(12) Patent Application Publication
(10) Pub. No.: US 2015/0371024 A1
(43) Pub. Date: Dec. 24, 2015

(54) SMART BAND AND BIOMETRIC AUTHENTICATION METHOD THEREOF

(71) Applicant: ZIKTO, Seoul (KR)

(72) Inventors: Kyung Tae KIM, Seoul (KR); Sung Hyun KIM, Seoul (KR); David Hansuk SUH, Seoul (KR)

(21) Appl. No.: 14/547,576

(22) Filed: Nov. 19, 2014

(30) Foreign Application Priority Data
Jun. 18, 2014 (KR) 10-2014-0074521

(51) Int. Cl. G06F 21/32

(52) U.S. Cl. CPC G06F 21/32

(57) ABSTRACT

Provided are smart band and biometric authentication method thereof. The biometric authentication method of a smart band, comprises generating motion data by measuring motion of a user via a motion sensor; extracting a plurality of feature points based on the generated motion data; and performing biometric authentication of the user based on a distribution state of the extracted feature points.

### CROSS-REFERENCE TO RELATED APPLICATION

This application claims priority from Korean Patent Application No. 10-2014-0074521 filed on Jun. 18, 2014 in the Korean Intellectual Property Office, and all the benefits accruing therefrom under 35 U.S.C. 119, the contents of which in its entirety are herein incorporated by reference.

### BACKGROUND

1. Technical Field

The present inventive concept relates to a smart band and a biometric authentication method thereof.

2. Description of the Related Art

Conventionally, in order to authenticate a user in a smart band associated with a smartphone, it is common to additionally install a biometric authentication module (e.g., fingerprint recognition module), or receive authentication information from the associated smartphone.

However, in such a user authentication method, there is a problem that it requires an additional circuit in the smart band, or a separate operation of the user, which may cause an increase in the manufacturing cost due to provision of the additional circuit and the user's discomfort.

### SUMMARY

The present invention provides a smart band capable of performing a user's authentication without an additional circuit or a separate operation of the user and a biometric authentication method thereof.

According to an aspect of the present invention, there is provided a biometric authentication method of a smart band, comprising: generating motion data by measuring motion of a user via a motion sensor; extracting a plurality of feature points based on the generated motion data; and performing biometric authentication of the user based on a distribution state of the extracted feature points.

The performing biometric authentication of the user based on a distribution state of the extracted feature points comprises: deriving a histogram of the extracted feature points; converting the derived histogram into a normalized histogram; comparing pre-registered user's biometric authentication information with a distribution state of feature points in the normalized histogram and checking whether an error between the pre-registered user's biometric authentication information and the distribution state of the feature points in the normalized histogram falls within an allowable error range; determining that the normalized histogram is identical with the pre-registered user's biometric authentication information if the error between the pre-registered user's biometric authentication information and the distribution state of the feature points in the normalized histogram falls within the allowable error range; and determining that the normalized histogram is not identical with the pre-registered user's biometric authentication information if the error between the pre-registered user's biometric authentication information and the distribution state of the feature points in the normalized histogram does not fall within the allowable error range.

The checking whether an error between the pre-registered user's biometric authentication information and the distribution state of the feature points in the normalized histogram falls within an allowable error range comprises: computing a score by calculating differences for respective sections between the normalized histogram and the pre-registered user's biometric authentication information and summing up absolute values of each of the differences, and determining whether the computed score is equal to or less than a reference value.

The biometric authentication method of a smart band further comprises, before said generating motion data by measuring motion of a user via the motion sensor: pre-registering biometric authentication information of the user for comparison with the normalized histogram, wherein said pre-registering biometric authentication information of the user for comparison with the normalized histogram comprises: generating motion data by measuring motion of a user via a motion sensor in response to a request for registration of biometric authentication information; extracting a plurality of feature points based on the generated motion data; deriving a histogram of the extracted feature points; converting the derived histogram into a normalized histogram; and registering the normalized histogram as the biometric authentication information of the user.

Each of the feature points is a magnitude of acceleration.

Each of the feature points is a magnitude of rotational angular velocity.

Each of the feature points is a result obtained by performing Fourier transformation on a magnitude of acceleration or a magnitude of rotational angular velocity.

According to another aspect of the present invention, there is provided a smart band comprising: a motion sensor to generate motion data by measuring motion of a user; and a biometric authentication unit to extract a plurality of feature points based on the generated motion data and perform biometric authentication of the user based on a distribution state of the extracted feature points.

The biometric authentication unit derives a histogram of the extracted feature points, converts the derived histogram into a normalized histogram, compares pre-registered user's biometric authentication information with a distribution state of feature points in the normalized histogram to check whether an error between the pre-registered user's biometric authentication information and the distribution state of the feature points in the normalized histogram falls within an allowable error range, determines that the normalized histogram is identical with the pre-registered user's biometric authentication information if the error between the pre-registered user's biometric authentication information and the distribution state of the feature points in the normalized histogram falls within the allowable error range, and determines that the normalized histogram is not identical with the pre-registered user's biometric authentication information if the error between the pre-registered user's biometric authentication information and the distribution state of the feature points in the normalized histogram does not fall within the allowable error range.

The biometric authentication unit computes a score by calculating differences for respective sections between the normalized histogram and the pre-registered user's biometric authentication information and summing up absolute values of each of the differences, and determines whether the computed score is equal to or less than a reference value to check whether the error between the pre-registered user's biometric authentication information and the distribution state of the feature points in the normalized histogram falls within the allowable error range.

The biometric authentication unit, before performing the biometric authentication of the user, generates motion data by measuring motion of the user via a motion sensor in response to a request for registration of biometric authentication information, extracts a plurality of feature points based on the generated motion data, derives a histogram of the extracted feature points, converts the derived histogram into a normalized histogram, and registers the normalized histogram as the biometric authentication information of the user.

Each of the feature points is a magnitude of acceleration.

Each of the feature points is a magnitude of rotational angular velocity.

Each of the feature points is a result obtained by performing Fourier transformation on a magnitude of acceleration or a magnitude of rotational angular velocity.

However, aspects of the present invention are not restricted to the one set forth herein. The above and other aspects of the present invention will become more apparent to one of ordinary skill in the art to which the present invention pertains by referencing the detailed description of the present invention given below.

The present invention provides an advantage of performing biometric authentication with only walking while wearing the smart band without an additional circuit or a separate operation of the user.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram showing a smart band according to an embodiment of the present invention and a smartphone associated with the smart band;

FIG. 2 is a block diagram showing a device configuration of the smart band according to the embodiment of the present invention;

FIG. 3 is a flowchart showing a method of registering biometric authentication information in the smart band according to the embodiment of the present invention;

FIG. 4 is a flowchart showing a method of performing biometric authentication based on the biometric authentication information registered in the smart band according to the embodiment of the present invention;

FIG. 5 is an exemplary diagram illustrating a method for performing the user's biometric authentication by extracting the magnitude of the acceleration as a feature point in the smart band having an acceleration sensor according to the embodiment of the present invention;

FIG. 6 is an exemplary diagram illustrating a method for performing the user's biometric authentication by extracting the magnitude of the rotational angular velocity as a feature point in the smart band having a gyroscope according to the embodiment of the present invention; and

FIG. 7 is an exemplary diagram illustrating a method for performing the user's biometric authentication by extracting the result obtained by performing Fourier transformation on the magnitude of the acceleration or the magnitude of the angular velocity as a feature point in the smart band having an acceleration sensor or a gyroscope according to the embodiment of the present invention.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, a smart band and a biometric authentication method thereof according to an embodiment of the present invention will be described.

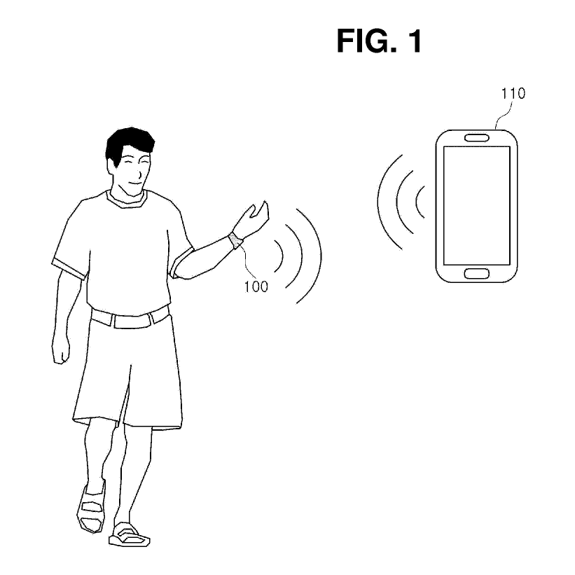

FIG. 1 is a diagram showing a smart band according to an embodiment of the present invention and a smartphone associated with the smart band.

Referring to FIG. 1, a smart band 100 according to the embodiment of the present invention communicates with a smartphone 110 by using short-range communication. The smart band 100 is wearable on a human body (e.g., arm) by using a band and the like. The smart band 100 includes a motion sensor, generates motion data by measuring the motion of a user via the motion sensor, and performs biometric authentication of the user based on the motion data. Accordingly, the user can perform biometric authentication with only walking while wearing the smart band 100 without a separate operation. Since each user has a different arm moving pattern when walking, the user's biometric authentication can be performed by measuring the motion of the arm.

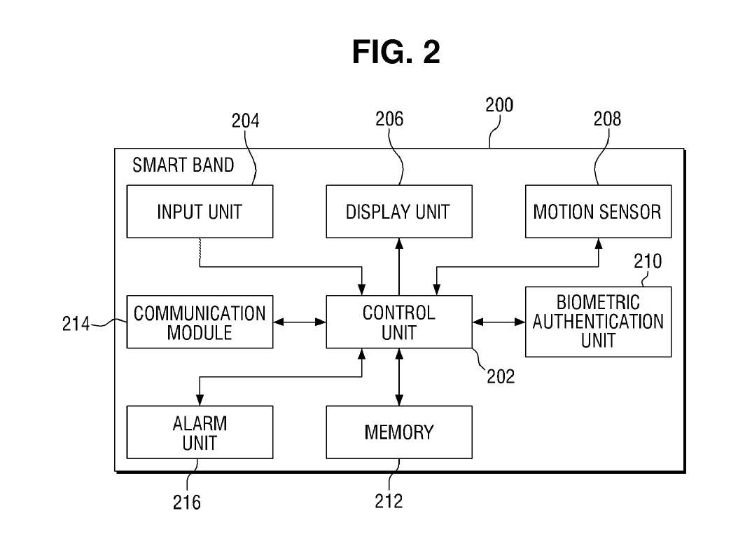

FIG. 2 is a block diagram showing a device configuration of the smart band according to the embodiment of the present invention.

Referring to FIG. 2, a smart band 200 according to the embodiment of the present invention includes a control unit 202, an input unit 204, a display unit 206, a motion sensor 208, a biometric authentication unit 210, a memory 212, a communication module 214 and an alarm unit 216.

The control unit 202 generates motion data by measuring the motion of the user via the motion sensor 208, and processes a function to perform biometric authentication of the user based on the motion data.

The input unit 204 may be configured as a plurality of function keys, and provides key input data corresponding to the key pressed by the user to the control unit 202. The functions of the input unit 204 and the display unit 206 may be performed by a touch screen unit (not shown). In this case, the touch screen unit (not shown) enables touch screen input through the user's touch on the screen and graphic screen output through the touch screen.

The display unit 206 displays status information generated during the operation of the smart band 200, a limited number of characters, a large amount of videos and still images and the like. A liquid crystal display (LCD) may be used as the display unit 206.

The motion sensor 208 is implemented as a sensor such as an acceleration sensor or a gyroscope. The motion sensor 208 is activated periodically or according to the control of the biometric authentication unit 210, and measures the motion of the user. The motion sensor 208 generates motion data including the measurement results and provides the motion data to the biometric authentication unit 210.

If it is determined that the biometric authentication of the user is necessary, the biometric authentication unit 210 activates the motion sensor 208, extracts a plurality of feature points based on the motion data generated by the motion sensor 208, and performs the biometric authentication of the user based on a distribution state of the extracted feature points. In some embodiments, the biometric authentication unit 210 may derive a histogram of the extracted feature points, convert the derived histogram into a normalized histogram, compare pre-registered biometric authentication information of the user with a distribution state of feature points in the normalized histogram, and check whether an error between the pre-registered user's biometric authentication information and the distribution state of the feature points in the normalized histogram falls within an allowable error range. If the error between the pre-registered user's biometric authentication information and the distribution state of the feature points in the normalized histogram falls within the allowable error range, the biometric authentication unit 210 may determine that the normalized histogram is identical with the pre-registered user's biometric authentication information. If the error between the pre-registered user's biometric authentication information and the distribution state of the feature points in the normalized histogram does not fall within the allowable error range, the biometric authentication unit 210 may determine that the normalized histogram is not identical with the pre-registered user's biometric authentication information.

The biometric authentication unit 210 pre-registers the biometric authentication information of the user for comparison with the normalized histogram in response to a request for registration of biometric authentication information before performing the biometric authentication of the user. In some embodiments, the biometric authentication unit 210 may activate the motion sensor 208 in response to the request for registration of biometric authentication information according to the user's key operation, extract a plurality of feature points based on the motion data generated by the motion sensor 208, derive a histogram of the extracted feature points, convert the derived histogram into a normalized histogram, and register the normalized histogram as the user's biometric authentication information.

The memory 212 stores a variety of reference data and microcodes of a program for processing and control of the control unit 202, temporary data generated during execution of various programs, and various kinds of updatable data for storage. In particular, the memory 212 stores the pre-registered user's biometric authentication information.

The communication module 214 encodes a signal inputted from the control unit 202, and transmits the encoded signal to the smartphone through short-range wireless communication such as Bluetooth, ZigBee, infrared, Ultra Wide Band (UWB), WLAN and Near Field Communication (NFC). Further, the communication module 214 decodes a signal received from the smartphone through the short-range wireless communication, and provides the decoded signal to the control unit 202.

The alarm unit 216 informs the user of the success/failure of the user's biometric authentication under the control of the biometric authentication unit 210. In this case, the alarm unit 216 may output an alarm such that the user can recognize the success/failure of the user's biometric authentication through human sense such as vision and hearing. For example, it is possible to output a beep or turn on/off a warning light by using a buzzer or a light emitting diode (LED). Alternatively, by displaying guidance on the display unit 206, it is possible to output an alarm informing the success/failure of the user's biometric authentication.

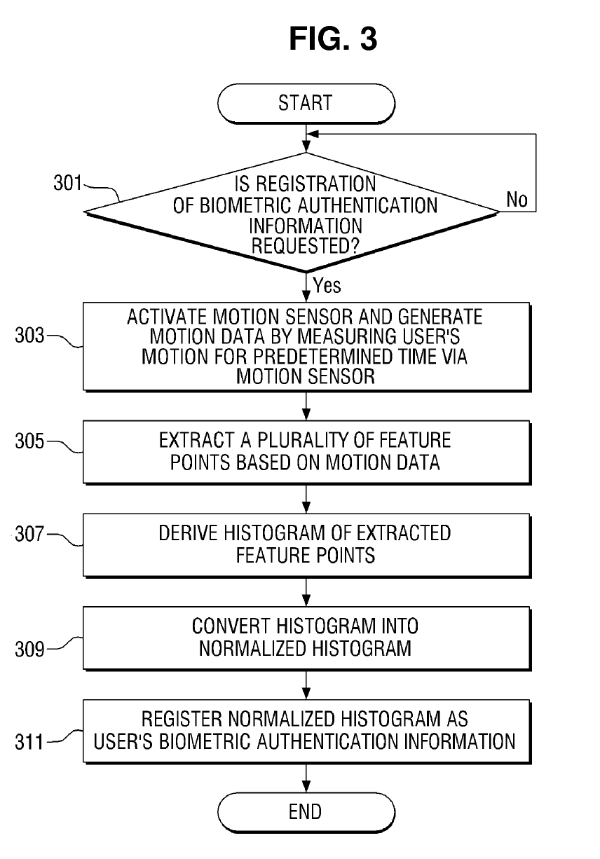

FIG. 3 is a flowchart showing a method of registering biometric authentication information in the smart band according to the embodiment of the present invention.

Referring to FIG. 3, the smart band checks whether the registration of the biometric authentication information is requested according to the user's key operation in step 301.

If the registration of the biometric authentication information is requested according to the user's key operation in step 301, the smart band activates the motion sensor 208, and generates motion data by measuring the motion of the user for a predetermined time via the motion sensor 208 in step 303. For example, if the motion sensor is an acceleration sensor, acceleration data is generated by measuring the acceleration for the user's motion, and if the motion sensor is a gyroscope, angular velocity data is generated by measuring the rotational angular velocity for the user's motion. In this case, the acceleration data includes acceleration components in three (x, y, and z) axes, and the angular velocity data includes angular velocity components in three axes.

Then, the smart band extracts a plurality of feature points based on the motion data generated for the motion for a predetermined time in step 305. For example, if the motion data is acceleration data, the magnitude of the acceleration may be a feature point, and the magnitude of the acceleration may be calculated as a root of the sum of the squares of the acceleration components in three axes. Further, if the motion data is angular velocity data, the magnitude of the angular velocity may be a feature point, and the magnitude of the angular velocity may be calculated as a root of the sum of the squares of the angular velocity components in three axes. Further, the result obtained by performing Fourier transformation on the magnitude of the acceleration or the magnitude of the angular velocity may be a feature point.

Then, the smart band derives a histogram of the extracted feature points in step 307. The histogram is a graph showing a distribution state of the extracted feature points.

Then, the smart band converts the derived histogram into a normalized histogram to facilitate the comparison between histograms when performing the biometric authentication afterwards in step 309.

Subsequently, the smart band registers the normalized histogram as the biometric authentication information of the user in step 311.

Then, the smart band ends the algorithm according to the present invention.

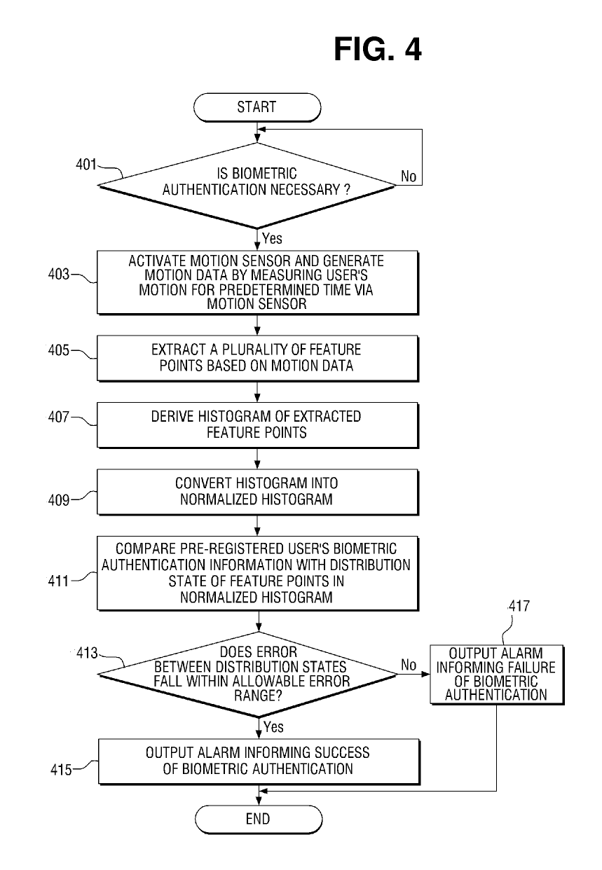

FIG. 4 is a flowchart showing a method of performing biometric authentication based on the biometric authentication information registered in the smart band according to the embodiment of the present invention.

Referring to FIG. 4, the smart band checks whether the user's biometric authentication is necessary periodically in step 401.

If it is determined that the user's biometric authentication is necessary in step 401, the smart band activates the motion sensor, and generates motion data by measuring the motion of the user for a predetermined time via the motion sensor in step 403. For example, if the motion sensor is an acceleration sensor, acceleration data is generated by measuring the acceleration for the user's motion, and if the motion sensor is a gyroscope, angular velocity data is generated by measuring the rotational angular velocity for the user's motion. In this case, the acceleration data includes acceleration components in three (x, y, and z) axes, and the angular velocity data includes angular velocity components in three axes.

Then, the smart band extracts a plurality of feature points based on the motion data generated for the motion for a predetermined time in step 405. For example, if the motion data is acceleration data, the magnitude of the acceleration may be a feature point, and the magnitude of the acceleration may be calculated as a root of the sum of the squares of the acceleration components in three axes. Further, if the motion data is angular velocity data, the magnitude of the angular velocity may be a feature point, and the magnitude of the angular velocity may be calculated as a root of the sum of the squares of the angular velocity components in three axes. Further, the result obtained by performing Fourier transformation on the magnitude of the acceleration or the magnitude of the angular velocity may be a feature point.

Then, the smart band derives a histogram of the extracted feature points in step 407. The histogram is a graph showing a distribution state of the extracted feature points.

Then, the smart band converts the derived histogram into a normalized histogram in step 409.

Subsequently, the smart band compares pre-registered biometric authentication information of the user with a distribution state of feature points in the normalized histogram in step 411.

Then, the smart band checks whether an error between the pre-registered user's biometric authentication information and the distribution state of the feature points in the normalized histogram falls within an allowable error range in step 413. For example, the smart band may compute a score by calculating differences for respective sections between the normalized histogram and the pre-registered user's biometric authentication information (i.e., pre-registered normalized histogram of the user) and adding absolute values thereof, and determine whether the computed score is equal to or less than a reference value, thereby checking whether the error between the pre-registered user's biometric authentication information and the distribution state of the feature points in the normalized histogram falls within the allowable error range. In this case, the lower the computed score, the higher the similarity between two normalized histograms. In some embodiments, the smart band may include two or more different kinds of motion sensors. In this case, whether the error between the pre-registered user's biometric authentication information and the distribution state of the feature points in the normalized histogram falls within the allowable error range may be checked by computing two or more scores based on the motion data generated via two or more motion sensors, computing a final score by adding the computed two or more scores after being weighed, and determining whether the computed final score is equal to or less than a reference value.

If the error between the pre-registered user's biometric authentication information and the distribution state of the feature points in the normalized histogram falls within the allowable error range in step 413, the smart band determines that the normalized histogram is identical with the pre-registered user's biometric authentication information and outputs an alarm informing the success of the user's biometric authentication in step 415.

On the other hand, if the error between the pre-registered user's biometric authentication information and the distribution state of the feature points in the normalized histogram does not fall within the allowable error range in step 413, the smart band determines that the normalized histogram is not identical with the pre-registered user's biometric authentication information and outputs an alarm informing the failure of the user's biometric authentication in step 417.

Then, the smart band ends the algorithm according to the present invention.

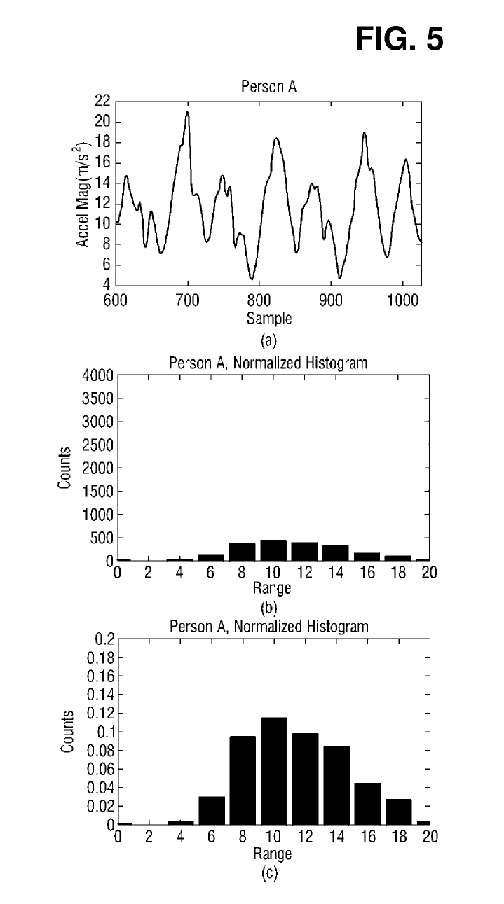

FIG. 5 is an exemplary diagram illustrating a method for performing the user's biometric authentication by extracting the magnitude of the acceleration as a feature point in the smart band having an acceleration sensor according to the embodiment of the present invention.

Referring to FIG. 5, if the user only walks after wearing the smart band having the acceleration sensor without a separate operation, the smart band may generate acceleration data by measuring the acceleration of the user's motion, calculate the magnitude of the acceleration based on the acceleration data, and extract a plurality of feature points as shown in (a) of FIG. 5. Then, the smart band may derive a histogram of the extracted feature points as shown in (b) of FIG. 5, convert the derived histogram into a normalized histogram as shown in (c) of FIG. 5, and compare the normalized histogram with pre-registered biometric authentication information of the user (i.e., pre-registered normalized histogram of the user), thereby performing the authentication of the user.

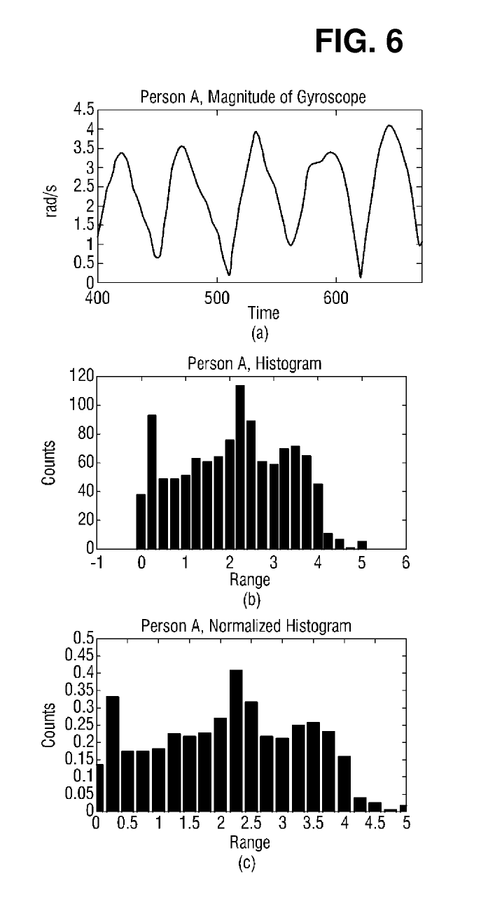

FIG. 6 is an exemplary diagram illustrating a method for performing the user's biometric authentication by extracting the magnitude of the rotational angular velocity as a feature point in the smart band having a gyroscope according to the embodiment of the present invention.

Referring to FIG. 6, if the user only walks after wearing the smart band having the gyroscope without a separate operation, the smart band may generate angular velocity data by measuring the rotational angular velocity of the user's motion, calculate the magnitude of the angular velocity based on the angular velocity data, and extract a plurality of feature points as shown in (a) of FIG. 6. Then, the smart band may derive a histogram of the extracted feature points as shown in (b) of FIG. 6, convert the derived histogram into a normalized histogram as shown in (c) of FIG. 6, and compare the normalized histogram with pre-registered biometric authentication information of the user (i.e., pre-registered normalized histogram of the user), thereby performing the authentication of the user.

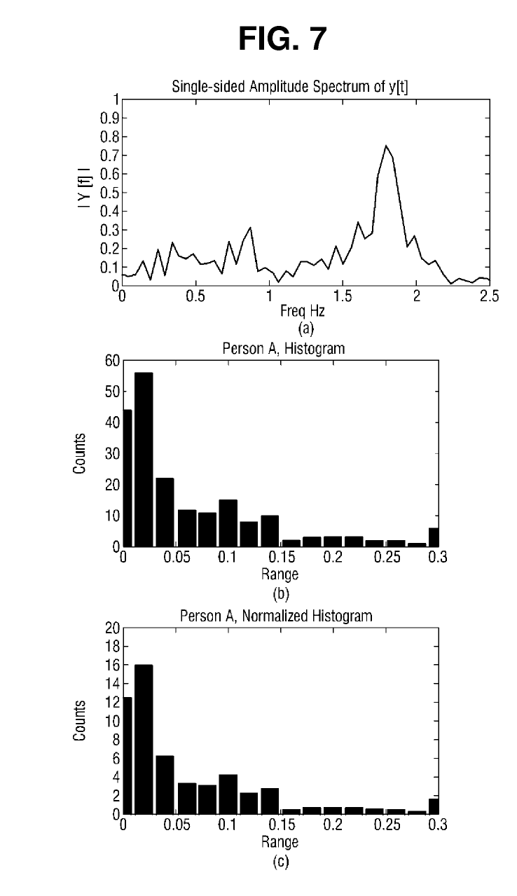

FIG. 7 is an exemplary diagram illustrating a method for performing the user's biometric authentication by extracting the result obtained by performing Fourier transformation on the magnitude of the acceleration or the magnitude of the angular velocity as a feature point in the smart band having an acceleration sensor or a gyroscope according to the embodiment of the present invention.

Referring to FIG. 7, if the user only walks after wearing the smart band having the acceleration sensor or the gyroscope without a separate operation, the smart band may generate acceleration data or angular velocity data by measuring the acceleration or the rotational angular velocity of the user's motion, calculate the magnitude of the acceleration or the magnitude of the angular velocity based on the acceleration data or the angular velocity data, and extract a plurality of feature points as shown in (a) of FIG. 7. Then, the smart band may derive a histogram of the extracted feature points as shown in (b) of FIG. 7, convert the derived histogram into a normalized histogram as shown in (c) of FIG. 7, and compare the normalized histogram with pre-registered biometric authentication information of the user (i.e., pre-registered normalized histogram of the user), thereby performing the authentication of the user.

As described above, in the smart band and the biometric authentication method thereof according to the embodiment of the present invention, motion data is generated by measuring the user's motion via the motion sensor, and the user's biometric authentication is performed based on the motion data. Thus, there is an advantage of performing biometric authentication with only walking while wearing the smart band without an additional circuit or a separate operation of the user.

Although preferred embodiments of the present inventive concept have been described for illustrative purposes, those skilled in the art will appreciate that various modifications, additions and substitutions are possible, without departing from the scope and spirit of the inventive concept as disclosed in the accompanying claims.

What is claimed is:

1. A biometric authentication method of a smart band, comprising:
generating motion data by measuring motion of a user via a motion sensor;
extracting a plurality of feature points based on the generated motion data; and
performing biometric authentication of the user based on a distribution state of the extracted feature points,
wherein the plurality of feature points is a result obtained by performing Fourier transformation on a magnitude of acceleration or a magnitude of rotational angular velocity.

2. The biometric authentication method of claim 1, wherein said performing biometric authentication of the user based on a distribution state of the extracted feature points comprises:
deriving a histogram of the extracted feature points;
converting the derived histogram into a normalized histogram;
comparing pre-registered user's biometric authentication information with a distribution state of feature points in the normalized histogram and checking whether an error between the pre-registered user's biometric authentication information and the distribution state of the feature points in the normalized histogram falls within an allowable error range;
determining that the normalized histogram is identical with the pre-registered user's biometric authentication information if the error between the pre-registered user's biometric authentication information and the distribution state of the feature points in the normalized histogram falls within the allowable error range.

3. The biometric authentication method of claim 2, wherein said checking whether an error between the pre-registered user's biometric authentication information and the distribution state of the feature points in the normalized histogram falls within an allowable error range comprises:
computing a score by calculating differences for respective sections between the normalized histogram and the pre-registered user's biometric authentication information and summing up absolute values of each of the differences, and determining whether the computed score is equal to or less than a reference value.

4. The biometric authentication method of claim 2, further comprising, before said generating motion data by measuring motion of a user via the motion sensor: pre-registering biometric authentication information of the user for comparison with the normalized histogram,
wherein said pre-registering biometric authentication information of the user for comparison with the normalized histogram comprises:
generating motion data by measuring motion of a user via a motion sensor in response to a request for registration of biometric authentication information;
extracting a plurality of feature points based on the generated motion data;
deriving a histogram of the extracted feature points;
converting the derived histogram into a normalized histogram; and
registering the normalized histogram as the biometric authentication information of the user.

5. A smart band comprising:
a motion sensor to generate motion data by measuring motion of a user; and
a biometric authentication unit to extract a plurality of feature points based on the generated motion data and perform biometric authentication of the user based on a distribution state of the extracted feature points,
wherein the plurality of feature points is a result obtained by performing Fourier transformation on a magnitude of acceleration or a magnitude of rotational angular velocity.

6. The smart band of claim 5, wherein the biometric authentication unit derives a histogram of the extracted feature points,
converts the derived histogram into a normalized histogram,
compares pre-registered user's biometric authentication information with a distribution state of feature points in the normalized histogram to check whether an error between the pre-registered user's biometric authentication information and the distribution state of the feature points in the normalized histogram falls within an allowable error range,
determines that the normalized histogram is identical with the pre-registered user's biometric authentication information if the error between the pre-registered user's biometric authentication information and the distribution state of the feature points in the normalized histogram falls within the allowable error range.

7. The smart band of claim 6, wherein the biometric authentication unit computes a score by calculating differences for respective sections between the normalized histogram and the pre-registered user's biometric authentication information and summing up absolute values of each of the differences, and determines whether the computed score is equal to or less than a reference value to check whether the error between the pre-registered user's biometric authentication information and the distribution state of the feature points in the normalized histogram falls within the allowable error range.

8. The smart band of claim 6, wherein the biometric authentication unit, before performing the biometric authentication of the user, generates motion data by measuring motion of the user via a motion sensor in response to a request for registration of biometric authentication information,
extracts a plurality of feature points based on the generated motion data,
derives a histogram of the extracted feature points,
converts the derived histogram into a normalized histogram, and
registers the normalized histogram as the biometric authentication information of the user.
